(19) United States
(12) Patent Application Publication
(10) Pub. No.: US 2012/0224639 A1
(43) Pub. Date: Sep. 6, 2012

(54) METHOD FOR INTERPOLATING HALF PIXELS AND QUARTER PIXELS

(75) Inventors: Jian Lou, San Diego, CA (US); Koohyar Minoo, San Diego, CA (US); Krit Panusopone, San Diego, CA (US); Limin Wang, San Diego, CA (US)

(73) Assignee: GENERAL INSTRUMENT CORPORATION, Horsham, PA (US)

(21) Appl. No.: 13/408,609

(22) Filed: Feb. 29, 2012

Related U.S. Application Data
(60) Provisional application No. 61/448,867, filed on Mar. 3, 2011.

(51) Int. Cl. H04N 7/32

(52) U.S. Cl. 375/240.17; 375/E07.105

(57) ABSTRACT

A method and system for interpolating video pixels is described, in which the values of a first quarter pixel, a half pixel and a second quarter pixel are calculated based on certain interpolation filter coefficients.

### CROSS REFERENCE TO RELATED APPLICATIONS

The present application claims the benefit of priority to U.S. Provisional Patent Application Ser. No. 61/448,867, filed on Mar. 3, 2011, entitled “High Efficiency Half Pixel and Quarter Pixel Interpolation Filters,” by Lou, et al., which is hereby incorporated by reference in its entirety.

The present application is related to U.S. patent application Ser. No. ______ filed on ______, entitled “A METHOD AND SYSTEM FOR INTERPOLATING FRACTIONAL VIDEO PIXELS,” by Lou, et al.

### TECHNICAL FIELD

The present invention relates generally to video image processing and, more particularly, to methods and systems for interpolating video pixels.

### BACKGROUND

One of the major characteristics of conventional motion compensated hybrid video codec is use of translational model for motion description. Pixel value of a digital video sequence represents the light intensity from certain object that falls into the detection range of some discrete sensor. Since an object motion is completely unrelated to the sampling grid, sometimes the object motion is more like a fractional-pel motion than a full-pel one. Therefore, most modern hybrid video coding standards use fractional-pel displacement vector resolution of ½-pel or ¼-pel.

In order to estimate and compensate fractional-pel displacements, the image signal on these fractional-pel positions has to be generated by interpolation process. The taps of an interpolation filter weight the integer pixels in order to generate the fractional-pel signals. The simplest filter for fractional-pel signal interpolation is bilinear filter, but there is no improvement beyond ⅛-pel (See Cliff Reader, “History of MPEG Video Compression”, JVT of ISO/IEC MPEG and ITU-T VCEG, Docs. JVT-E066, October 2002). Therefore, only ½-pel resolution using bilinear interpolation is adopted in MPEG-2 and H.263.

Werner supposes the reason for poor performance of bilinear filter is that the Nyquist Sampling Theorem is not fulfilled and aliasing disturbs the motion compensated prediction. He proposes Wiener interpolation filters for reducing the impact of aliasing (See O. Werner, “Drift analysis and, drift reduction for multiresolution hybrid video coding,” Signal Processing: Image Commun., vol. 8, no. 5, July 1996). Thus, recent video coding standards like MPEG-4 part 2 and H.264 apply 8-tap and 6-tap Wiener interpolation filters respectively. These filters are obtained by solving the Wiener-Hopf equations. The equations should be specified for filters with different filter length and the resultant taps are limited within a range while different video sequences are used as the input signals.

### BRIEF DESCRIPTION OF THE DRAWINGS

Various embodiments of the present invention will be described below in more detail, with reference to the accompanying drawings.

It is to be noted, however, that the appended drawings illustrate embodiments of this invention and are therefore not to be considered limiting of its scope, for the invention may admit to other equally effective embodiments.

FIG. 1A is a video system in which the various embodiments of the invention may be used;

FIG. 1B is a computer system on which embodiments of the invention may be implemented;

FIGS. 2A, 2B, 3A and 3B illustrate certain video encoding principles according to an embodiment of the invention;

FIGS. 4A and 4B show possible architectures for an encoder and a decoder according to an embodiment of the invention;

FIGS. 5A and 5B illustrate further video coding principles according to an embodiment of the invention; and

FIG. 6 illustrates a pixel line.

### DETAILED DESCRIPTION

An example of a video system in which an embodiment of the invention may be used will now be described. It is understood that elements depicted as function blocks in the figures may be implemented as hardware, software, or a combination thereof. Furthermore, embodiments of the invention may also be employed on other systems, such as on a personal computer. smartphone or tablet computer.

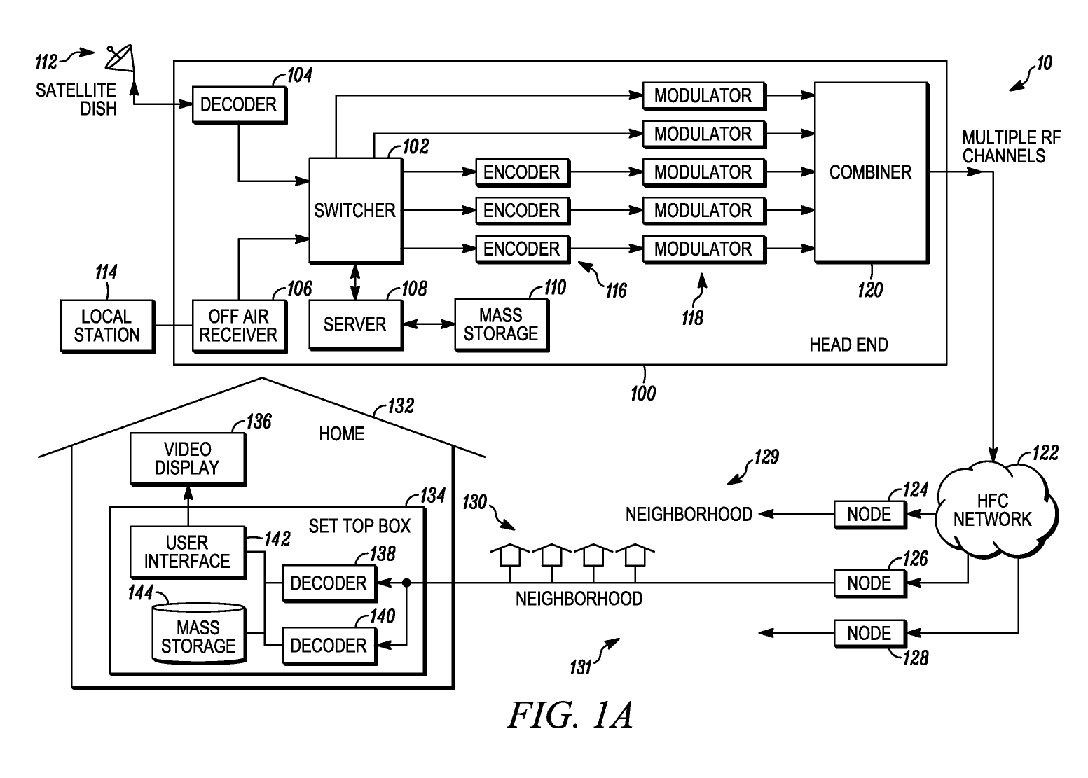

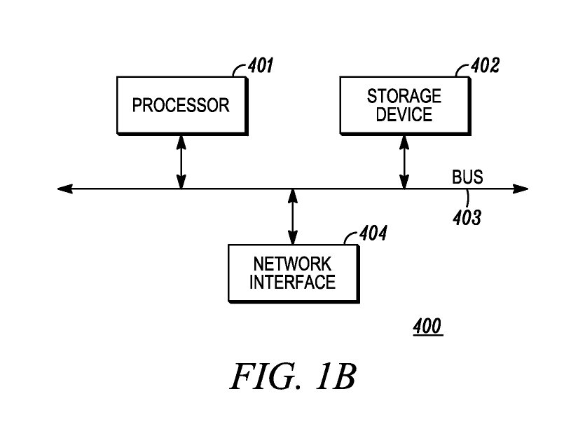

Referring to FIG. 1A, the video system, generally labeled 10, includes a head end 100 of a cable television network. The head end 100 is configured to deliver video content to neighborhoods 129, 130 and 131. The head end 100 may operate within a hierarchy of head ends, with the head ends higher in the hierarchy generally having greater functionality. The head end 100 is communicatively linked to a satellite dish 112 and receives video signals for non-local programming from it. The head end 100 is also communicatively linked to a local station 114 that delivers local programming to the head end 100. The head end 100 includes a decoder 104 that decodes the video signals received from the satellite dish 112, an off-air receiver 106 that receives the local programming from the local station 114, a switcher 102 that routes data traffic among the various components of the head end 100, encoders 116 that encode video signals for delivery to customers, modulators 118 that modulate signals for delivery to customers, and a combiner 120 that combines the various signals into a single, multi-channel transmission.

The head end 100 is also communicatively linked to a hybrid fiber cable (HFC) network 122. The HFC network 122 is communicatively linked to a plurality of nodes 124, 126, and 128. Each of the nodes 124, 126, and 128 is linked by coaxial cable to one of the neighborhoods 129, 130 and 131 and delivers cable television signals to that neighborhood. One of the neighborhoods 130 of FIG. 1A is shown in more detail. The neighborhood 130 includes a number of residences, including a home 132 shown in FIG. 1A. Within the home 132 is a set-top box 134 communicatively linked to a video display 136. The set-top box 134 includes a first decoder 138 and a second decoder 140. The first and second decoders 138 and 140 are communicatively linked to a user interface 142 and a mass storage device 144. The user interface 142 is communicatively linked to the video display 136.

During operation, head end 100 receives local and nonlocal programming video signals from the satellite dish 112 and the local station 114. The nonlocal programming video signals are received in the form of a digital video stream, while the local programming video signals are received as an analog video stream. In some embodiments, local programming may also be received as a digital video stream. The digital video stream is decoded by the decoder 104 and sent to the switcher 102 in response to customer requests. The head end 100 also includes a server 108 communicatively linked to a mass storage device 110. The mass storage device 110 stores various types of video content, including video on demand (VOD), which the server 108 retrieves and provides to the switcher 102. The switcher 102 routes local programming directly to the modulators 118, which modulate the local programming, and routes the non-local programming (including any VOD) to the encoders 116. The encoders 116 digitally encode the non-local programming. The encoded non-local programming is then transmitted to the modulators 118. The combiner 120 receives the modulated analog video data and the modulated digital video data, combines the video data and transmits it via multiple radio frequency (RF) channels to the HFC network 122.

The HFC network 122 transmits the combined video data to the nodes 124, 126 and 128, which retransmit the data to their respective neighborhoods 129, 130 and 131. The home 132 receives this video data at the set-top box 134, more specifically at the first decoder 138 and the second decoder 140. The first and second decoders 138 and 140 decode the digital portion of the video data and provide the decoded data to the user interface 142, which then provides the decoded data to the video display 136.

The encoders 116 and the decoders 138 and 140 of FIG. 1A (as well as all of the other steps and functions described herein) may be implemented as computer code comprising computer readable instructions stored on a computer readable storage device, such as memory or another type of storage device. The computer code is executed on a computer system by a processor, such as an application-specific integrated circuit (ASIC), or other type of circuit. For example, computer code for implementing the encoders 116 may be executed on a computer system (such as a server) residing in the headend 100. Computer code for the decoders 138 and 140, on the other hand, may be executed on the set-top box 134, which constitutes a type of computer system. The code may exist as software programs comprised of program instructions in source code, object code, executable code or other formats.

FIG. 1B shows an example of a computer system on which computer code for the encoders 116 and the decoders 138 and 140 may be executed. The computer system, generally labeled 400, includes a processor 401, or processing circuitry, that may implement or execute software instructions performing some or all of the methods, functions and other steps described herein. Commands and data from processor 401 are communicated over a communication bus 403. Computer system 400 also includes a computer readable storage device 402, such as random access memory (RAM), where the software and data for processor 401 may reside during runtime. Storage device 402 may also include non-volatile data storage. Computer system 400 may include a network interface 404 for connecting to a network. Other known electronic components may be added or substituted for the components depicted in the computer system 400. The computer system 400 may reside in the headend 100 and execute the encoders 116, and may also be embodied in the set-top box 134 to execute the decoders 138 and 140. Additionally, the computer system 400 may reside in places other than the headend 100 and the set-top box 134, and may be miniaturized so as to be integrated into a smartphone or tablet computer.

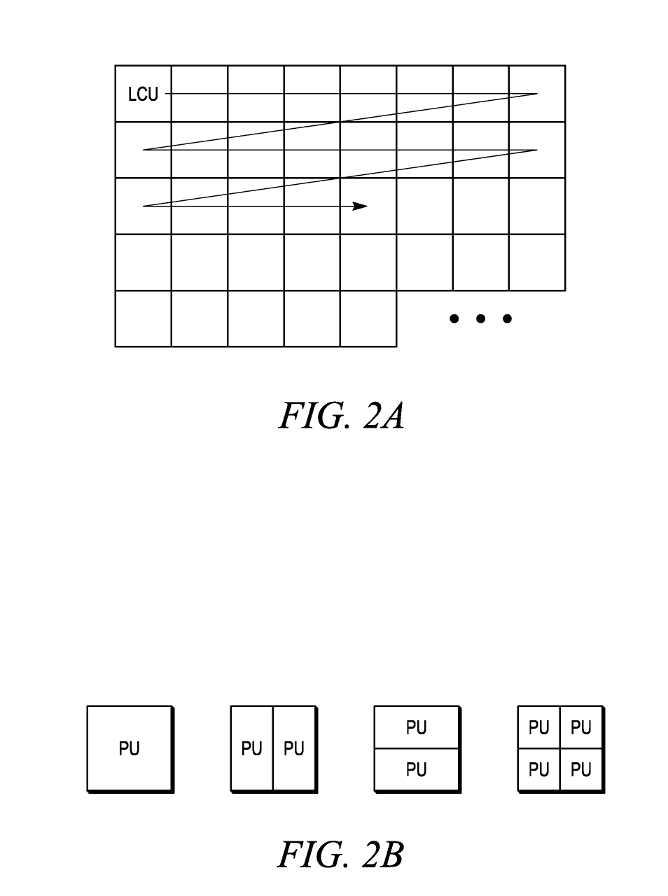

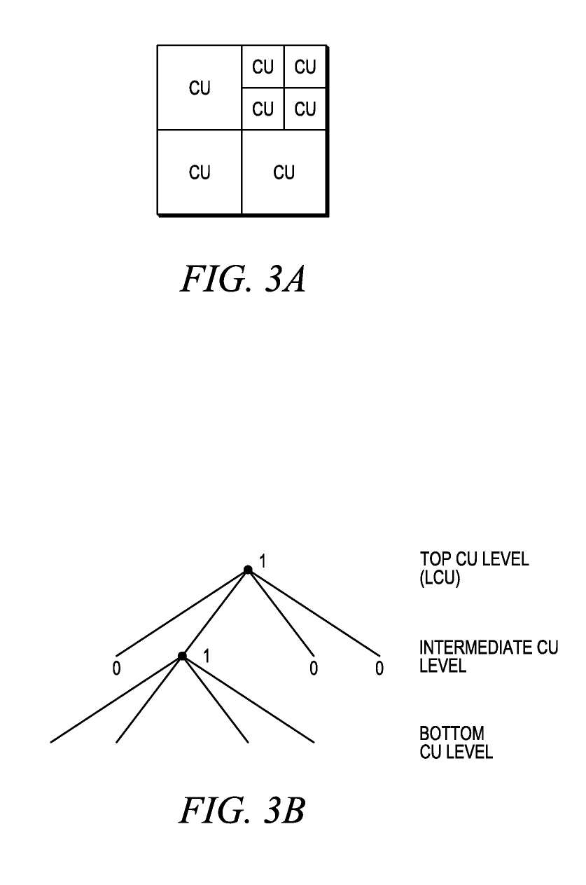

A high-level description of how video data gets encoded and decoded by the encoders 116 and the decoders 138 and 140 in an embodiment of the invention will now be provided. In this embodiment, the encoders and decoders operate according to a High Efficiency Video Coding (HEVC) method. HEVC is a block-based hybrid spatial and temporal predictive coding method. In HEVC, an input picture is first divided into square blocks, called LCUs (largest coding units), as shown in FIG. 2A. Unlike other video coding standards, in which the basic coding unit is a Macroblock of 16×16 pixels, in HEVC, the LCU can be as large as 128×128 pixels. An LCU can be divided into four square blocks, called CUs (coding units), which are a quarter of the size of the LCU. Each CU can be further split into four smaller CUs, which are a quarter of the size of the original CU. The splitting process can be repeated until certain criteria are met. FIG. 3A shows an example of LCU partitioned into CUs.

How a particular LCU is split into CUs can be represented by a quadtree. At each node of the quadtree, a flag is set to “1” if the node is further split into sub-nodes. Otherwise, a the flag is unset at “0.” For example, the LCU partition of FIG. 3A can be represented by the quadtree of FIG. 3B. These “split flags” are jointly coded with other flags in the video bitstream, including a skip mode flag, a merge mode flag, and a predictive unit (PU) mode flag. In the case of the quadtree of FIG. 3B, the split flags 10100 would be coded as overhead along with the other flags.

Each CU can be further divided into predictive units (PUs). Thus, at each leaf of a quadtree, a final CU of 2N×2N can possess one of four possible patterns (N×N, N×2N, 2N×N and 2N×2N), as shown in FIG. 2B. A CU can be either spatially or temporally predictive coded. If a CU is coded in intra mode, each PU of the CU can have its own spatial prediction direction. If a CU is coded in inter mode, each PU of the CU can have its own motion vector(s) and associated reference picture(s).

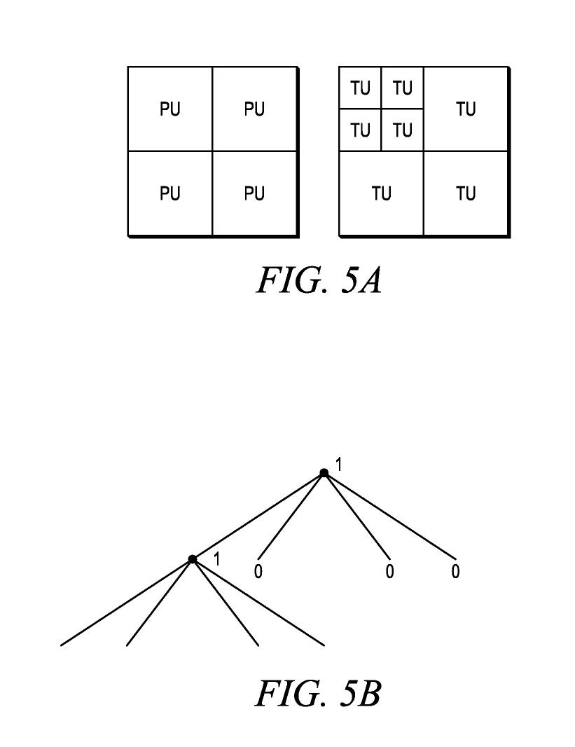

Each CU can also be divided into transform units (TUs) by application of a block transform operation. A block transform operation tends to decorrelate the pixels within the block and compact the block energy into the low order coefficients of the transform block. But, unlike other methods where only one transform of 8×8 or 4×4 is applied to a MB, in the present embodiment, a set of block transforms of different sizes may be applied to a CU, as shown in FIG. 5A where the left block is a CU partitioned into PUs and the right block is the associated set of transform units (TUs). The size and location of each block transform within a CU is described by a separate quadtree, called RQT. FIG. 5B shows the quadtree representation of TUs for the CU in the example of FIG. 5A. In this example, 11000 is coded and transmitted as part of the overhead.

The TUs and PUs of any given CU may be used for different purposes. TUs are typically used for transformation, quantizing and coding operations, while PUs are typically used for spatial and temporal prediction. There is not necessarily a direct relationship between the number of PUs and the number of TUs for a given CU.

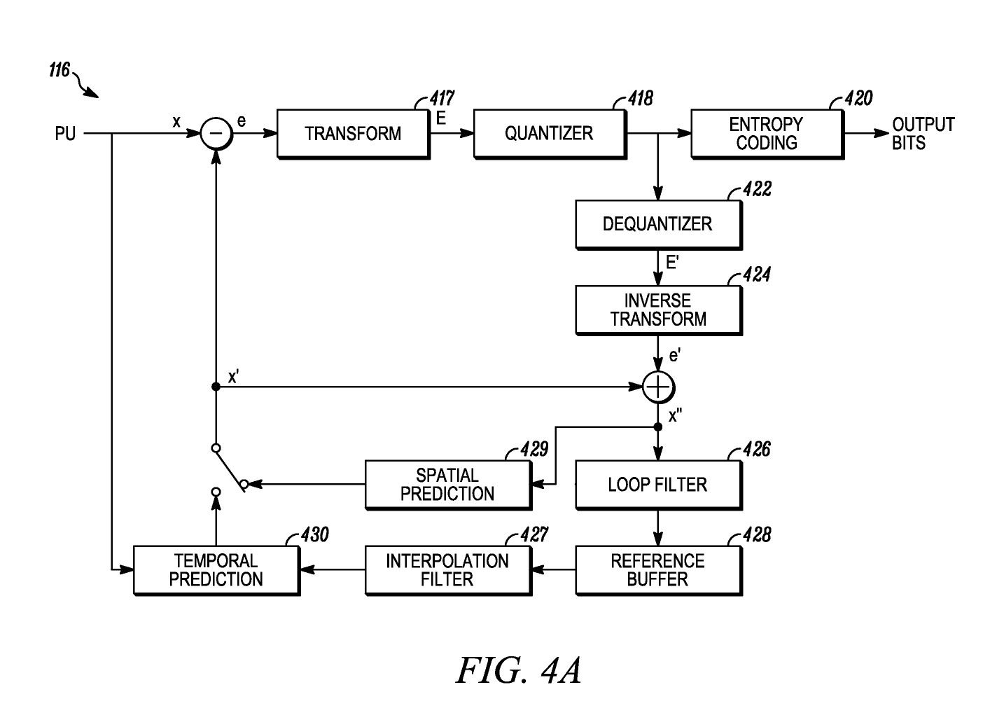

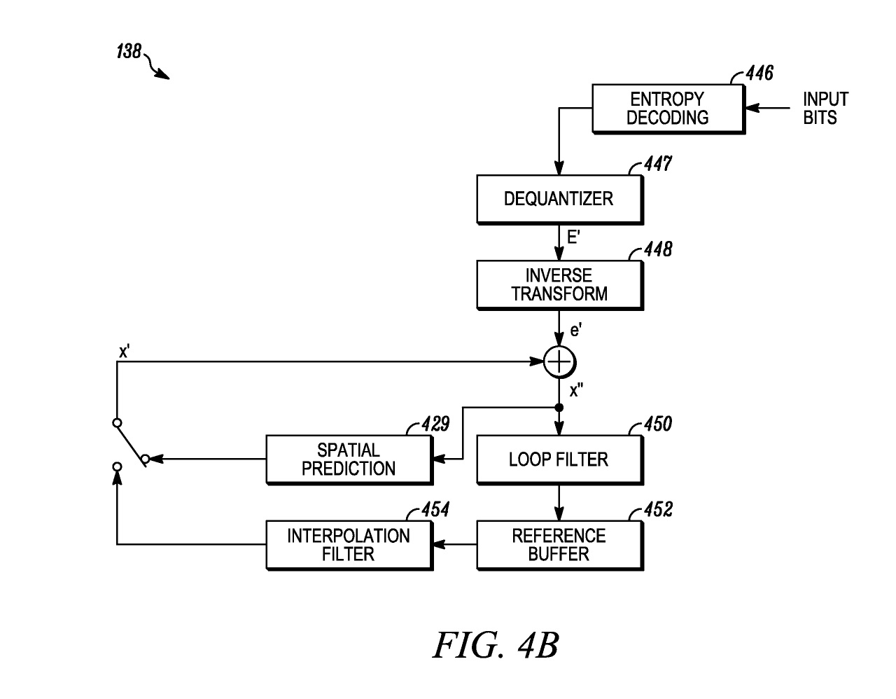

Each of the encoders 116 (FIG. 1A) is, according to an embodiment of the invention, composed of several functional modules. These modules are depicted in FIG. 4A. It is understood that these modules may be implemented as hardware, software, or any combination of the two. The input to the encoder 116 of FIG. 4A is a current PU, x. Given the current PU, x, a prediction PU, x′, is first obtained through either spatial prediction or temporal prediction. This spatial or temporal prediction is performed by a spatial prediction module 429 or a temporal prediction module 430 respectively.

There are several possible spatial prediction directions that the spatial prediction module 429 can perform per PU, including horizontal, vertical, 45-degree diagonal, 135-degree diagonal, DC, Planar, etc. In one embodiment, the number of Luma intra prediction modes for 4×4, 8×8, 16×16, 32×32, and 64×64 blocks is 18, 35, 35, 35, and 4 respectively. Including the Luma intra modes, an additional mode, called IntraFromLuma, may be used for the Chroma intra prediction mode. A syntax indicates the spatial prediction direction per PU.

The encoder 116 performs temporal prediction through motion estimation operation. In one embodiment, the temporal prediction module 430 (FIG. 4A) searches for a best match prediction for the current PU over reference pictures. The best match prediction is described by motion vector (MV) and associated reference picture (refldx). A PU in B pictures can have up to two MVs. Both MV and refldx are part of the syntax in the bitstream.

The prediction PU is then subtracted from the current PU, resulting in the residual PU, e. The residual PU, e, is then transformed by a transform module 417, one transform unit (TU) at a time, resulting in the residual PU in the transform domain, E. To accomplish this task, the transform module 417 uses either a square or a non-square block transform.

Referring back to FIG. 4A, the transform coefficients E, are quantized by a quantizer module 418, converting the high precision transform coefficients into a finite number of possible values. The quantized coefficients are then entropy coded by an entropy coding module 420, resulting in the final compression bits. Two types of entropy coding that may be used are context adaptive variable length coding (CAVLC) and context adaptive binary arithmetic encoding (CABAC). Other types may also be used.

To facilitate temporal and spatial prediction, the encoder 116 also takes the quantized transform coefficients E and dequantizes them with a dequantizer module 422 resulting in the dequantized transform coefficients of E′. The dequantized transform coefficients of E′ are then inverse transformed by an inverse transform module 424, resulting in the reconstructed residual PU, e′. The reconstructed residual PU, e′, is then added to the corresponding prediction, x′, either spatial or temporal, to form a reconstructed PU, x″.

Referring still to FIG. 4A, a loop filter operation is performed on the reconstructed PU, x″ by a loop filter module 426. One possible way in which this loop filtering operation may be performed is by a deblocking filter operation, which reduces blocking artifacts. Another possible way is by a sample adaptive offset process. Additionally, an adaptive loop filter function may be conditionally performed, which minimizes the coding distortion between the input and output pictures. Any combination of loop filtering operations may also be performed by the loop filter 426. For example, a sample adaptive offset process may be conditionally performed after the completion of a deblocking filter process for the decoded picture, which compensates the pixel value offset between reconstructed pixels and original pixels.

If the reconstructed pictures are reference pictures, they will be stored in a reference buffer 428 for future temporal prediction. From the reference buffer 428, reference pictures are subjected to the operation of an interpolation filter 427. As will be described in more detail, the interpolation filter performs operations that include calculating fractional pixels. The reference pictures are then provided to the temporal prediction module 430.

In an embodiment of the invention, intra pictures (such as an I picture) and inter pictures (such as P pictures or B pictures) are supported by the encoder 116 (FIG. 1A). When implemented according to HEVC, the inter pictures are B pictures. An intra picture is coded without referring to other pictures. Hence, spatial prediction is used for a CU/PU inside an intra picture. An intra picture provides a possible point where decoding can begin. On the other hand, an inter picture aims for high compression. Inter picture supports both intra and inter prediction. A CU/PU in inter picture is either spatially or temporally predictive coded. Temporal references are the previously coded intra or inter pictures.

The bits output by the entropy coding module 420 as well as the entropy encoded signs, significance map and non-zero coefficients are inserted into the bitstream by the encoder 116. This bitstream is sent to the decoders 138 and 140 over the HFC network 122 (FIG. 1A). When the decoders 138 and 140 (FIG. 1A) receive the bitstream, they performs the functions shown in FIG. 4B. An entropy decoding module 446 of the decoder 138 decodes the sign values, significance map and non-zero coefficients to recreate the quantized and transformed coefficients. The entropy decoding module 446 then provides the coefficients to a dequantizer module 447, which dequantizes the matrix of coefficients, resulting in E′. The dequantizer module 447 provides the dequantized coefficients to an inverse transform module 448. The inverse transform module 448 performs an inverse transform operation on the coefficients resulting in the reconstructed residual PU, e′. The reconstructed residual PU, e′, is then added to the corresponding spatial prediction, x′ to form a reconstructed PU, x″.

Referring still to FIG. 4B, a loop filter module 450 performs a loop filtering operation on the reconstructed PU. Possible ways in which the loop filtering operation may be performed are discussed previously in conjunction with the loop filtering module 426 of FIG. 4A. If the reconstructed pictures are reference pictures, they will be stored in a reference buffer 452 for future temporal prediction. From the reference buffer 452, reference pictures are subjected to the operation of an interpolation filter 454. As will be described in more detail, the interpolation filter 454 performs operations that include calculating fractional pixels.

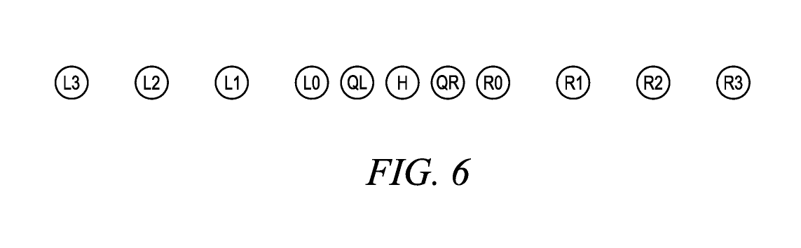

Various methods for interpolating fractional pixels according to embodiments of the invention will now be described. These methods may be carried out on the video system of FIG. 1A, the computer system of FIG. 1B, or on any similar system. When implemented in conjunction with the encoder 116 or decoder 138 depicted in FIGS. 4A and 4B, these methods may be carried out by the interpolation filter 427 (FIG. 4A) and the interpolation filter 454 (FIG. 4B). The methods will be described with reference to FIG. 6, which depicts a pixel line. The pixel line includes a first integer pixel (R0), a second integer pixel (L0), a third integer pixel (L1), a fourth integer pixel (R1), a fifth integer pixel (L2), a sixth integer pixel (R2), a seventh integer pixel (L3), an eighth integer pixel (R3), a ninth integer pixel (L4), a tenth integer pixel (R4), an eleventh integer pixel (L5) and a twelfth integer pixel (R6). As can be seen in FIG. 6, the L0 and R0 are between L1 and R1. L1 and R1 are between L2 and R2, L2 and R2 are between L3 and R3, L3 and R3 are between L4 and R4, and L4 and R4 are between L5 and R5.

Between integer pixels L0 and R0 are quarter pixels QL and QR, as well as half pixel H. The pixel line represents pixels of an image that are oriented in a substantially straight line with respect to one another. This line is shown in FIG. 6 as being horizontal. However it is understood that the line may be oriented in any direction, including vertical or diagonal, and may extend to any dimension. Quarter pixels QL and QR are often referred to as “quarter-pel pixels,” while half pixel H is sometimes referred to “half-pel pixel.”

### Embodiment I

In this embodiment, the half-pel pixel, H, and quarter-pel pixels, QL and QR, are interpolated using the values of spatial neighboring full-pel pixels, L3, L2, L1, L0, R0, R1, R2, and R3, as follows,

QL=(−1*L3+4*L2−10*L1+58*L0+17*R0−6*R1+3*R2−1*R3+32)>>6;

H=(−1*L3+4*L2−11*L1+40*L0+40*R0−11*R1+4*R2−1*R3+32)>>6;

QR=(−1*L3+3*L2−6*L1+17*L0+58*R0−10*R1+4*R2−1*R3+32)>>6;

Table 1 summarizes the filter coefficients.

TABLE 1

| Position | Coefficients |
|---|---|
| ¼ | { −1, 4, −10, 58, 17, −6, 3, −1,} |
| ½ | { −1, 4, −11, 40, 40, −11, 4, −1,} |
| ¾ | { −1, 3, −6, 17, 58, −10, 4, −1,} |

### Embodiment II

In this embodiment, the half-pel pixel, H, and quarter-pel pixels, QL and QR, are interpolated using the values of spatial neighboring full-pel pixels, L3, L2, L1, L0, R0, R1, R2, and R3, as follows,

QL=(−1*L3+4*L2−10*L1+55*L0+21*R0−7*R1+3*R2−1*R3+32)>>6;

H=(−1*L3+4*L2−11*L1+40*L0+40*R0−11*R1+4*R2−1*R3+32)>>6;

QR=(−1*L3+3*L2−7*L1+21*L0+55*R0−10*R1+4*R2−1*R3+32)>>6;

Table 2 summarizes the filter coefficients.

TABLE 2

| Position | Coefficients |
|---|---|
| ¼ | { −1, 4, −10, 55, 21, −7, 3, −1,} |
| ½ | { −1, 4, −11, 40, 40, −11, 4, −1,} |
| ¾ | { −1, 3, −7, 21, 55, −10, 4, −1,} |

### Embodiment III

In this embodiment, the half-pel pixel, H, and quarter-pel pixels, QL and QR, are interpolated using the values of spatial neighboring full-pel pixels, L3, L2, L1, L0, R0, R1, R2, and R3, as follows,

QL=(−1*L3+3*L2−10*L1+55*L0+22*R0−7*R1+3*R2−1*R3+32)>>6;

H=(−1*L3+4*L2−11*L1+40*L0+40*R0−11*R1+4*R2−1*R3+32)>>6;

QR=(−1*L3+3*L2−7*L1+22*L0+55*R0−10*R1+3*R2−1*R3+32)>>6;

Table 3 summarizes the filter coefficients.

TABLE 3

| Position | Coefficients |
|---|---|
| ¼ | { −1, 3, −10, 55, 22, −7, 3, −1,} |
| ½ | { −1, 4, −11, 40, 40, −11, 4, −1,} |
| ¾ | { −1, 3, −7, 22, 55, −10, 3, −1,} |

### Embodiment IV

QL=(−1*L3+5*L2−8*L1+55*L0+21*R0−10*R1+3*R2−1*R3+32)>>6;

H=(−1*L3+4*L2−11*L1+40*L0+40*R0−11*R1+4*R2−1*R3+32)>>6;

QR=(−1*L3+3*L2−10*L1+21*L0+55*R0−8*R1+5*R2−1*R3+32)>>6;

Table 4 summarizes the filter coefficients.

TABLE 4

| Position | Coefficients |
|---|---|
| ¼ | { −1, 5, −8, 55, 21, −10, 3, −1,} |
| ½ | { −1, 4, −11, 40, 40, −11, 4, −1,} |
| ¾ | { −1, 3, −10, 21, 55, −8, 5, −1,} |

### Embodiment V

In this embodiment, the half-pel pixel, H, and quarter-pel pixels, QL and QR, are interpolated using the values of spatial neighboring full-pel pixels, L3, L2, L1, L0, R0, R1, R2, and R3, as follows,

QL=(−1*L3+5*L2−8*L1+54*L0+22*R0−10*R1+3*R2−1*R3+32)>>6;

H=(−1*L3+4*L2−11*L1+40*L0+40*R0−11*R1+4*R2−1*R3+32)>>6;

QR=(−1*L3+3*L2−10*L1+22*L0+54*R0−8*R1+5*R2−1*R3+32)>>6;

Table 5 summarizes the filter coefficients.

TABLE 5

| Position | Coefficients |
|---|---|
| ¼ | { −1, 5, −8, 54, 22, −10, 3, −1,} |
| ½ | { −1, 4, −11, 40, 40, −11, 4, −1,} |
| ¾ | { −1, 3, −10, 22, 54, −8, 5, −1,} |

### Embodiment VI

In this embodiment, the half-pel pixel, H, and quarter-pel pixels, QL and QR, are interpolated using the values of spatial neighboring full-pel pixels, L3, L2, L1, L0, R0, R1, R2, and R3, as follows,

QL=(−1*L3+3*L2−9*L1+57*L0+18*R0−6*R1+2*R2−0*R3+32)>>6;

H=(−1*L3+4*L2−11*L1+40*L0+40*R0−11*R1+4*R2−1*R3+32)>>6;

QR=(−0*L3+2*L2−6*L1+18*L0+57*R0−9*R1+3*R2−1*R3+32)>>6;

Table 6 summarizes the filter coefficients.

TABLE 6

| Position | Coefficients |
|---|---|
| ¼ | { −1, 3, −9, 57, 18, −6, 2, 0,} |
| ½ | { −1, 4, −11, 40, 40, −11, 4, −1,} |
| ¾ | {0, 2, −6, 18, 57, −9, 3, −1,} |

From the experimental results tested on the JCT-VC reference software, HM2.0,

The interpolation filter of Embodiment I may achieve 0.5% bitrate savings when encoding sequence Vidyo1 using high efficiency test condition, while increase 1.4% bitrate when encoding sequence Vidyo1 using low complexity test conditions.

The interpolation filter of Embodiment II may achieve 0.6% bitrate savings when encoding sequence RaceHorses using low complexity test condition, while increase 3.4% bitrate when encoding sequence Vidyo1 using low complexity test condition.

The interpolation filter of Embodiment III may achieve 1.1% bitrate savings when encoding sequence Vidyo3 using low complexity test condition, while increase 5.2% bitrate when encoding sequence BQSquare using low complexity test condition.

The interpolation filter of Embodiment VI may achieve 1.7% bitrate savings when encoding sequence Vidyo3 using low complexity test condition, while increase 1.1% bitrate when encoding sequence BlowingBubbles using low complexity test condition.

A specific interpolation filter may work well for certain types of video contents. It might be preferable to adaptively choose the interpolation filter(s). Thus, different interpolation filter(s) may be used for different video sequences.

In addition, the characteristics of the pixels along the horizontal lines and the vertical lines may be very different. Hence, separable filters may be employed in the horizontal and vertical directions. The separable horizontal and vertical filters may not necessarily the same, depending upon the video content. For example, a coding unit or a picture with mostly horizontal detail could use a stronger vertical filter, etc.

The filter selection information can be signaled explicitly, or derived implicitly, at sequence, picture, slice or even CU level.

Although described specifically throughout the entirety of the instant disclosure, representative examples have utility over a wide range of applications, and the above discussion is not intended and should not be construed to be limiting. The terms, descriptions and figures used herein are set forth by way of illustration only and are not meant as limitations. Those skilled in the art recognize that many variations are possible within the spirit and scope of the examples. While the examples have been described with reference to examples, those skilled in the art are able to make various modifications to the described examples without departing from the scope of the examples as described in the following claims, and their equivalents.

What is claimed is:

1. A method for interpolating a first quarter pixel (QL), a half pixel (H), and a second quarter pixel (QR) along a pixel line, the pixel line comprising a first integer pixel (L3), a second integer pixel (L2), a third integer pixel (L1), a fourth integer pixel (L0), a fifth integer pixel (R0), a sixth integer pixel (R1), a seventh integer pixel (R2) and an eighth integer pixel (R3), the method comprising:
calculating the value of the first quarter pixel (QL) based on the equation
QL=(−1*L3+4*L2−10*L1+58*L0+17*R0−6*R1+3*R2−1*R3+32)>>6;
calculating the value of the half pixel (H) based on the equation
H=(−1*L3+4*L2−11*L1+40*L0+40*R0−11*R1+4*R2−1*R3+32)>>6; and
calculating the value of the second quarter pixel (QR) based on the equation
QR=(−1*L3+3*L2−6*L1+17*L0+58*R0−10*R1+4*R2−1*R3+32)>>6.

2. A method for interpolating a first quarter pixel (QL), a half pixel (H), and a second quarter pixel (QR) along a pixel line, the pixel line comprising a first integer pixel (L3), a second integer pixel (L2), a third integer pixel (L1), a fourth integer pixel (L0), a fifth integer pixel (R0), a sixth integer pixel (R1), a seventh integer pixel (R2) and an eighth integer pixel (R3), the method comprising:
calculating the value of the first quarter pixel (QL) based on the equation
QL=(−1*L3+4*L2−10*L1+55*L0+21*R0−7*R1+3*R2−1*R3+32)>>6;
calculating the value of the half pixel (H) based on the equation
H=(−1*L3+4*L2−11*L1+40*L0+40*R0−11*R1+4*R2−1*R3+32)>>6; and
calculating the value of the second quarter pixel (QR) based on the equation
QR=(−1*L3+3*L2−6*L1+17*L0+58*R0−10*R1+4*R2−1*R3+32)>>6.

3. A method for interpolating a first quarter pixel (QL), a half pixel (H), and a second quarter pixel (QR) along a pixel line, the pixel line comprising a first integer pixel (L3), a second integer pixel (L2), a third integer pixel (L1), a fourth integer pixel (L0), a fifth integer pixel (R0), a sixth integer pixel (R1), a seventh integer pixel (R2) and an eighth integer pixel (R3), the method comprising:
calculating the value of the first quarter pixel (QL) based on the equation
QL=(−1*L3+3*L2−10*L1+55*L0+22*R0−7*R1+3*R2−1*R3+32)>>6;
calculating the value of the half pixel (H) based on the equation
H=(−1*L3+4*L2−11*L1+40*L0+40*R0−11*R1+4*R2−1*R3+32)>>6; and
calculating the value of the second quarter pixel (QR) based on the equation
QR=(−1*L3+3*L2−7*L1+22*L0+55*R0−10*R1+3*R2−1*R3+32)>>6.

4. A method for interpolating a first quarter pixel (QL), a half pixel (H), and a second quarter pixel (QR) along a pixel line, the pixel line comprising a first integer pixel (L3), a second integer pixel (L2), a third integer pixel (L1), a fourth integer pixel (L0), a fifth integer pixel (R0), a sixth integer pixel (R1), a seventh integer pixel (R2) and an eighth integer pixel (R3), the method comprising:
calculating the value of the first quarter pixel (QL) based on the equation
QL=(−1*L3+5*L2−8*L1+55*L0+21*R0−10*R1+3*R2−1*R3+32)>>6;
calculating the value of the half pixel (H) based on the equation
H=(−1*L3+4*L2−11*L1+40*L0+40*R0−11*R1+4*R2−1*R3+32)>>6; and
calculating the value of the second quarter pixel (QR) based on the equation
QR=(−1*L3+3*L2−10*L1+21*L0+55*R0−8*R1+5*R2−1*R3+32)>>6.

5. A method for interpolating a first quarter pixel (QL), a half pixel (H), and a second quarter pixel (QR) along a pixel line, the pixel line comprising a first integer pixel (L3), a second integer pixel (L2), a third integer pixel (L1), a fourth integer pixel (L0), a fifth integer pixel (R0), a sixth integer pixel (R1), a seventh integer pixel (R2) and an eighth integer pixel (R3), the method comprising:
calculating the value of the first quarter pixel (QL) based on the equation
QL=(−1*L3+5*L2−8*L1+54*L0+22*R0−10*R1+3*R2−1*R3+32)>>6;
calculating the value of the half pixel (H) based on the equation
H=(−1*L3+4*L2−11*L1+40*L0+40*R0−11*R1+4*R2−1*R3+32)>>6; and
calculating the value of the second quarter pixel (QR) based on the equation
QR=(−1*L3+3*L2−10*L1+22*L0+54*R0−8*R1+5*R2−1*R3+32)>>6.

6. A method for interpolating a first quarter pixel (QL), a half pixel (H), and a second quarter pixel (QR) along a pixel line, the pixel line comprising a first integer pixel (L3), a second integer pixel (L2), a third integer pixel (L1), a fourth integer pixel (L0), a fifth integer pixel (R0), a sixth integer pixel (R1), a seventh integer pixel (R2) and an eighth integer pixel (R3), the method comprising:
calculating the value of the first quarter pixel (QL) based on the equation
QL=(−1*L3+3*L2−9*L1+57*L0+18*R0−6*R1+2*R2−0*R3+32)>>6;
calculating the value of the half pixel (H) based on the equation
H=(−1*L3+4*L2−11*L1+40*L0+40*R0−11*R1+4*R2−1*R3+32)>>6; and
calculating the value of the second quarter pixel (QR) based on the equation
QR=(−0*L3+2*L2−6*L1+18*L0+57*R0−9*R1+3*R2−1*R3+32)>>6.
